(19) United States
(12) Patent Application Publication
(10) Pub. No.: US 2013/0212032 A1
(43) Pub. Date: Aug. 15, 2013

(54) SKILL COMPETENCY SEARCH AND MANAGEMENT

(71) Applicants: Ian Robert Cox, Lambton North (AU); David Allen Greentree, Queanbeyan (AU)

(72) Inventors: Ian Robert Cox, Lambton North (AU); David Allen Greentree, Queanbeyan (AU)

(21) Appl. No.: 13/636,611

(22) PCT Filed: Mar. 25, 2011
(86) PCT No.: PCT/AU11/00344

§ 371 Date: Nov. 26, 2012

(30) Foreign Application Priority Data
Mar. 26, 2010 (AU) 2010901287
Sep. 23, 2011 (AU) 2011903935

(51) Int. Cl. G06Q 10/10

(52) U.S. Cl. CPC G06Q 10/1053
USPC 705/321

(57) ABSTRACT

A method, system, server processing system, and computer program product for conducting a skills competency search and/or managing skills acquisition for a user. In one aspect, the method includes, in a server processing system, steps of: receiving, from a client processing system in data communication with the server processing system, skills competency data indicative a user's competency for a set of skills; storing the skills competency data in a data store; receiving a skills acquisition notice indicative of a skills acquisition task completed by the user; obtaining skills acquisition data based upon the skills acquisition task; updating the skills competency data for the user according to the skills acquisition data; and generating a report indicative of the user's competency for the set of skills.

### CROSS REFERENCE TO RELATED APPLICATIONS

This application is a continuation-in-part application of the national phase entry of PCT/AU2011/000344 which is hereby incorporated by reference.

### FIELD OF INVENTION

The present invention relates to a method, system and computer program product for skill competency search and managing skills of a user.

### BACKGROUND

Generally, when a user seeks employment, the user may use an employment portal to conduct a search of a database to identify available employment. However, generally such a search is conducted by the user based upon a number of keywords indicative of the industry which the user requires employment within. This is not an ideal situation due to skills which have not been formally obtained via an institution may not be accounted for in the search results. Additionally, employment portals generally only provide a means for potential candidates to search for employment. Employers are generally a passive party waiting for applications from candidates.

Presently, it has become evident that approximately 80% of learning takes place in the workplace. However there is no effective system that allows individuals or workforces to take full advantage of the skills that are acquired by individuals within the workplace.

For example, if an individual transfers from one place of employment to another, it is difficult for the new employer to fully appreciate and value the skills which the individual has acquired at their previous workplace. For example, the employer may suspect that due to the individual having acquired little or no formal qualifications in relation to a specific skill set, a significant amount of training may be required for the respective individual. However, this may not be the case as the individual may have acquired the necessary skills at their previous employment.

Similar problems also exist if an individual wishes to undergo career progression.

Specifically, it may be difficult for the individual to identify the specific skills which he or she needs to acquire or improve upon in order to progress their career. This difficulty stems from the difficulty in assessing the current skills which the individual currently possesses due to their skills acquired via the workplace not being formalised in any manner.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

In particular aspects there is provided a method, system, server processing system and computer program product for determining suitable candidates for performing a skills competency search.

In one broad aspect there is provided a method of enabling a skill competency search, wherein the method includes, in a server processing system, steps of:
receiving, from a plurality of users, first data indicative of a respective user's level of competency for each skill of a skill set;
receiving, from a plurality of candidate seekers, second data indicative of a level of competency for each skill of the skill set which a respective candidate seeker desires for performing a respective task;
determining and presenting to one of the users, using the first and second data, a ranked list of tasks provided by corresponding candidate seekers; and
determining and presenting to one of the candidate seekers, using the first and second data, a ranked list of users to perform the respective task for the candidate seeker.

In another broad aspect there is provided a server processing system for enabling a skill competency search, wherein the server processing system is configured to:
receive, from a plurality of users, first data indicative of a respective user's level of competency for each skill of a skill set;
receive, from a plurality of candidate seekers, second data indicative of a level of competency for each skill of the skill set which a respective candidate seeker desires for performing a respective task;
determine and present to one of the users, using the first and second data, a ranked list of tasks provided by corresponding candidate seekers; and
determine and present to one of the candidate seekers, using the first and second data, a ranked list of users to perform the respective task for the candidate seeker.

In another broad aspect there is provided a computer program product for configuring a server processing system to enable a skill competency search, wherein the computer program product includes computer executable instructions for configuring the server processing system to:
receive, from a plurality of users, first data indicative of a respective user's level of competency for each skill of a skill set;
receive, from a plurality of candidate seekers, second data indicative of a level of competency for each skill of the skill set which a respective candidate seeker desires for performing a respective task;
determine and present to one of the users, using the first and second data, a ranked list of tasks provided by corresponding candidate seekers; and
determine and present to one of the candidate seekers, using the first and second data, a ranked list of users to perform the respective task for the candidate seeker.

Other aspects provide a method, system, server processing system and computer program product for managing skills acquisition for a user.

In one aspect there is provided a method of managing skills acquisition for a user, wherein the method includes, in a server processing system, steps of:
receiving, from a client processing system in data communication with the server processing system, skills competency data indicative a user's competency for a set of skills;
storing the skills competency data in a data store;
receiving a skills acquisition notice indicative of a skills acquisition task completed by the user;
obtaining skills acquisition data based upon the skills acquisition task;
updating the skills competency data for the user according to the skills acquisition data; and
generating a report indicative of the user's competency for the set of skills.

In one form, the data store has stored therein a plurality of skills acquisition task records, wherein each skills acquisition task record is indicative of a respective skills acquisition task and corresponding skills acquisition data, wherein the method includes the server processing system obtaining the skills acquisition data from the data store according to the skills acquisition task indicated by the skills acquisition notice.

In another form, the skills competency data and the skills acquisition data are arrays including a plurality of skill competency values indicative of a degree of competency for the set of skills.

In one embodiment, the method includes, in the server processing system, steps of:
comparing the skills competency data for the user against the skills acquisition data of the plurality of skills acquisition task records;
determining a recommended skills acquisition task for the user to undertake; and
transferring the recommended skills acquisition task to the client processing system.

In another embodiment, the method includes, in the server processing system, steps of:
determining, for each skills acquisition task and relative to the skills competency data, skills competency differential data for the set of skills;
determining, based upon the skills competency differential data, an average skills competency differential for each skills acquisition task; and
determining, based upon the average skills competency differential and a recommended skills acquisition task rule, the recommended skills acquisition task for the user.

In an optional form, the method includes the server processing system dismissing one or more skills acquisition tasks for recommendation in the event that the average skills competency differential is indicative of the user currently possessing a greater average skills competency for the set of skills.

In another optional form, the method includes the server processing system applying the recommended skills acquisition task rule to identify one of the skills acquisition tasks having an average skills competency differential which is closest to an optimum average skills competency differential compared to a remainder of the skills acquisition tasks, thereby identifying the recommended skills acquisition task.

In an optional embodiment, the method includes the server processing system determining an ordered list of recommended skills acquisition tasks, wherein the ordered list of recommended skills acquisition tasks is transferred to and presented by the client processing system in descending order of recommendation.

In another optional embodiment, the method includes, in the server processing system, steps of:
storing target skills competency data for the user in the data store;
comparing the skills competency data against the target skills competency data to generate target skills competency differential data; and
determining based upon the target skills competency differential data and at least some of the plurality of skills acquisition task records, one or more recommended skills acquisition tasks for the user to undertake.

Optionally, the method includes the server processing system receiving selection data from the client processing system, wherein the selection data is indicative of a selection made at the client processing system of the target skills competency data for the user.

In one form, the server processing system is configured to manage skills acquisition for a plurality of other users, wherein the method includes, in the server processing system, steps of:
receiving the selection data indicative of a selection of one of the other users as a target user for the user;
identifying, from the data store and based upon the selection data, skills competency data for the target user; and
storing the skills competency data for the target user as the target skills competency data for the user.

In another form, the method includes the server processing system comparing the skills competency data for the user against the skills acquisition data of the plurality of skills acquisition task records to determine an equivalent skills acquisition task which the user satisfies based upon the skills competency data for the user.

In one embodiment, the method includes, in the server processing system, steps of:
determining, for each skills acquisition task and relative to the skills competency data, skills competency differential data for the set of skills;
determining, based upon the skills competency differential data, an average skills competency differential for each skills acquisition task; and
determining, based upon the average skills competency differential for the plurality of skills acquisition tasks and using an equivalent skills acquisition task rule, the equivalent skills acquisition task which the user satisfies.

In another embodiment, the method includes the server processing system applying the equivalent skills acquisition task rule to identify the equivalent skills acquisition task having an average skills competency differential which is closest to zero.

In an optional form, the method includes the server processing system determining a plurality of equivalent skills acquisition tasks that the user satisfies based upon the skills competency data for the user.

In another optional form, the method includes the server processing system generating the report further indicative of the equivalent skills acquisition task.

In an optional embodiment, the method includes the server processing system:
determining a skills competency metric based upon the skills competency data for the user; and
recording, in the data store, the skills competency metric for the user.

In another optional embodiment, the step of determining the skills competency metric includes the server processing system performing a weighted summation of the plurality of skill competency values for the skills competency data for the user.

Optionally, the method includes the server processing system identifying, using the skills competency metric and a certification lookup table, an equivalent certification level for the user.

In one form, the method includes the server processing system generating the report to further be indicative of the equivalent certification level for the user.

In another form, at least some of the skills acquisition tasks are one of:
a qualification;
a certification; and
a training program.

In one embodiment, the method includes the server processing system:
receiving, from the client processing system, user personal data; and
generating, using the personal data, the report as a curriculum vitae.

In another broad aspect there is provided a server processing system for managing skills acquisition for a user, wherein the server processing system is configured to:
receive, from a client processing system in data communication with the server processing system, skills competency data indicative a user's competency for a set of skills;
store the skills competency data in a data store;
receive a skills acquisition notice indicative of a skills acquisition task completed by the user;
obtain skills acquisition data based upon the skills acquisition task;
update the skills competency data for the user according to the skills acquisition data; and
generate a report indicative of the user's competency for the set of skills.

In another broad aspect there is provided a computer program product stored upon a computer readable medium having computer executable instructions stored thereon for configuring a server processing system to manage skills acquisition for a user, wherein the computer executable instructions, when executed by a server processing system, configure the server processing to:
receive, from a client processing system in data communication with the server processing system, skills competency data indicative a user's competency for a set of skills;
store the skills competency data in a data store;
receive a skills acquisition notice indicative of a skills acquisition task completed by the user;
obtain skills acquisition data based upon the skills acquisition task;
update the skills competency data for the user according to the skills acquisition data; and
generate a report indicative of the user's competency for the set of skills.

In another aspect there is provided a method of enabling a skill competency search, wherein the method includes, in a server processing system, steps of:
receiving, from a plurality of users, first data indicative of a respective user's level of competency for each skill of a skill set;
receiving, from a plurality of candidate seekers, second data indicative of a level of competency for each skill of the skill set which a respective candidate seeker desires for performing a respective task;
determining and presenting to one of the users, using the first and second data, a ranked list of tasks provided by corresponding candidate seekers; and
determining and presenting to one of the candidate seekers, using the first and second data, a ranked list of users to perform the respective task for the candidate seeker.

In certain embodiments, the method includes the server processing system:
determining, based on the level of competency for each skill of the skill set for one of the tasks, a task skills competency index;
comparing the task skills competency index against a plurality of skills competency indexes for the plurality of users stored in a data store to determine a plurality of index differentials for the plurality of users; and
generating the ranked list of users to perform the respective task for the respective candidate seeker, wherein the ranked list is ranked according to the index differentials.

In certain embodiments, the method includes the server processing system:
determining, for each user and based upon the level of competency for each skill desired for one of the tasks provided by a respective candidate seeker, skills competency differential data;
determining, based upon the skills competency differential data for each user, an average skills competency differential for each user; and
generating the ranked list of users to perform the respective task for the respective candidate seeker, wherein the ranked list is ranked according to the average skills competency differential for each user.

In certain embodiments, the method includes the server processing system:
determining, for each user and based upon the level of competency for each skill of desired for one of the tasks provided by a respective candidate seeker, skills competency differential data;
determining, based upon the skills competency differential data for each user, an average skills competency differential for each user; and
determining, based on the average skills competency differential for each user and the level of competency for each skill for the respective task, skills competency differential frequency distribution data for each user;
generating the ranked list of users to perform the respective task for the respective candidate seeker, wherein the ranked list is ranked according to the skills competency differential frequency distribution data for each user.

In certain embodiments, the method includes the server processing system:
receiving search criteria from the candidate seeker indicative of an organisation which users presented in the ranked list are to be associated therewith; and
querying a data store to determine users associated with the organisation, wherein one or more users which are not associated with the organisation are filtered from the ranked list presented to the candidate seeker.

In certain embodiments, the method includes the server processing system:
determining, for one of the users and based on the first data, a skills competency index for the respective user;
comparing the skills competency index for the respective user against a plurality of task skills competency indexes for the plurality of tasks stored in a data store to determine a plurality of index differentials for the plurality of tasks; and
generating the ranked list of tasks for the respective user, wherein the ranked list is ranked according to the index differentials for each task.

In certain embodiments, the method includes the server processing system:
determining, for each task and based upon the level of competency for each skill indicated by the respective user, skills competency differential data for the set of skills;
determining, based upon the skills competency differential data for each task, an average skills competency differential for each task for the respective user; and
generating the ranked list of tasks for the respective user, wherein the ranked list is ranked according to the average skills competency differential for each task.

In certain embodiments, the method includes the server processing system:
determining, for each task and based the level of competency for each skill indicated by the respective user, skills competency differential data for the set of skills;
determining, based upon the skills competency differential data for each task, an average skills competency differential for each task for the respective user; and
determining, based upon the average skills competency differential for each task for the user and based on the first data, skills competency differential frequency distribution data for each task;
generating the ranked list of tasks for the user, wherein the ranked list is ranked according to the skills competency differential frequency distribution data for each task.

In another aspect there is provided a server processing system for enabling a skill competency search, wherein the server processing system is configured to:
receive, from a plurality of users, first data indicative of a respective user's level of competency for each skill of a skill set;
receive, from a plurality of candidate seekers, second data indicative of a level of competency for each skill of the skill set which a respective candidate seeker desires for performing a respective task;
determine and present to one of the users, using the first and second data, a ranked list of tasks provided by corresponding candidate seekers; and
determine and present to one of the candidate seekers, using the first and second data, a ranked list of users to perform the respective task for the candidate seeker.

In certain embodiments, the server processing system is configured to:
determine, based on the level of competency for each skill of the skill set for one of the tasks, a task skills competency index;
compare the task skills competency index against a plurality of skills competency indexes for the plurality of users stored in a data store to determine a plurality of index differentials for the plurality of users; and
generate the ranked list of users to perform the respective task for the respective candidate seeker, wherein the ranked list is ranked according to the index differentials.

In certain embodiments, the server processing system is configured to:
determine, for each user and based upon the level of competency for each skill desired for one of the tasks provided by a respective candidate seeker, skills competency differential data;
determine, based upon the skills competency differential data for each user, an average skills competency differential for each user; and
generate the ranked list of users to perform the respective task for the respective candidate seeker, wherein the ranked list is ranked according to the average skills competency differential for each user.

In certain embodiments, the server processing system is configured to:
determine, for each user and based upon the level of competency for each skill of desired for one of the tasks provided by a respective candidate seeker, skills competency differential data;
determine, based upon the skills competency differential data for each user, an average skills competency differential for each user; and
determine, based on the average skills competency differential for each user and the level of competency for each skill for the respective task, skills competency differential frequency distribution data for each user;
generate the ranked list of users to perform the respective task for the respective candidate seeker, wherein the ranked list is ranked according to the skills competency differential frequency distribution data for each user.

In certain embodiments, the server processing system is configured to:
receive search criteria from the candidate seeker indicative of an organisation which users presented in the ranked list are to be associated therewith; and
query a data store to determine users associated with the organisation, wherein one or more users which are not associated with the organisation are filtered from the ranked list presented to the candidate seeker.

In certain embodiments, the server processing system is configured to:
determine, for one of the users and based on the first data, a skills competency index for the respective user;
compare the skills competency index for the respective user against a plurality of task skills competency indexes for the plurality of tasks stored in a data store to determine a plurality of index differentials for the plurality of tasks; and
generate the ranked list of tasks for the respective user, wherein the ranked list is ranked according to the index differentials for each task.

In certain embodiments, the server processing system is configured to:
determine, for each task and based upon the level of competency for each skill indicated by the respective user, skills competency differential data for the set of skills;
determine, based upon the skills competency differential data for each task, an average skills competency differential for each task for the respective user; and
generate the ranked list of tasks for the respective user, wherein the ranked list is ranked according to the average skills competency differential for each task.

In certain embodiments, the server processing system is configured to:
determine, for each task and based the level of competency for each skill indicated by the respective user, skills competency differential data for the set of skills;
determine, based upon the skills competency differential data for each task, an average skills competency differential for each task for the respective user; and
determine, based upon the average skills competency differential for each task for the user and based on the first data, skills competency differential frequency distribution data for each task;
generate the ranked list of tasks for the user, wherein the ranked list is ranked according to the skills competency differential frequency distribution data for each task.

In another aspect there is provided a computer program for configuring a server processing system to enable a skill competency search, wherein the computer program includes computer executable instructions for configuring the server processing system to:
receive, from a plurality of users, first data indicative of a respective user's level of competency for each skill of a skill set;
receive, from a plurality of candidate seekers, second data indicative of a level of competency for each skill of the skill set which a respective candidate seeker desires for performing a respective task;
determine and present to one of the users, using the first and second data, a ranked list of tasks provided by corresponding candidate seekers; and
determine and present to one of the candidate seekers, using the first and second data, a ranked list of users to perform the respective task for the candidate seeker.

In certain embodiments, the server processing system is configured by the computer executable instructions to:
determine, based on the level of competency for each skill of the skill set for one of the tasks, a task skills competency index;
compare the task skills competency index against a plurality of skills competency indexes for the plurality of users stored in a data store to determine a plurality of index differentials for the plurality of users; and
generate the ranked list of users to perform the respective task for the respective candidate seeker, wherein the ranked list is ranked according to the index differentials.

In certain embodiments, the server processing system is configured by the computer executable instructions to:
determine, for each user and based upon the level of competency for each skill desired for one of the tasks provided by a respective candidate seeker, skills competency differential data;
determine, based upon the skills competency differential data for each user, an average skills competency differential for each user; and
generate the ranked list of users to perform the respective task for the respective candidate seeker, wherein the ranked list is ranked according to the average skills competency differential for each user.

In certain embodiments, the server processing system is configured by the computer executable instructions to:
determine, for each user and based upon the level of competency for each skill of desired for one of the tasks provided by a respective candidate seeker, skills competency differential data;
determine, based upon the skills competency differential data for each user, an average skills competency differential for each user; and
determine, based on the average skills competency differential for each user and the level of competency for each skill for the respective task, skills competency differential frequency distribution data for each user;
generate the ranked list of users to perform the respective task for the respective candidate seeker, wherein the ranked list is ranked according to the skills competency differential frequency distribution data for each user.

In certain embodiments, the server processing system is configured by the computer executable instructions to:
receive search criteria from the candidate seeker indicative of an organisation which users presented in the ranked list are to be associated therewith; and
query a data store to determine users associated with the organisation, wherein one or more users which are not associated with the organisation are filtered from the ranked list presented to the candidate seeker.

In certain embodiments, the server processing system is configured by the computer executable instructions to:
determine, for one of the users and based on the first data, a skills competency index for the respective user;
compare the skills competency index for the respective user against a plurality of task skills competency indexes for the plurality of tasks stored in a data store to determine a plurality of index differentials for the plurality of tasks; and
generate the ranked list of tasks for the respective user, wherein the ranked list is ranked according to the index differentials for each task.

In certain embodiments, the server processing system is configured by the computer executable instructions to:
determine, for each task and based upon the level of competency for each skill indicated by the respective user, skills competency differential data for the set of skills;
determine, based upon the skills competency differential data for each task, an average skills competency differential for each task for the respective user; and
generate the ranked list of tasks for the respective user, wherein the ranked list is ranked according to the average skills competency differential for each task.

In certain embodiments, the server processing system is configured by the computer executable instructions to:
determine, for each task and based the level of competency for each skill indicated by the respective user, skills competency differential data for the set of skills;
determine, based upon the skills competency differential data for each task, an average skills competency differential for each task for the respective user; and
determine, based upon the average skills competency differential for each task for the user and based on the first data, skills competency differential frequency distribution data for each task;
generate the ranked list of tasks for the user, wherein the ranked list is ranked according to the skills competency differential frequency distribution data for each task.

Other embodiments will be appreciated from the detailed description.

### BRIEF DESCRIPTION OF DRAWINGS

Example embodiments should become apparent from the following description, which is given by way of example only, of at least one preferred but non-limiting embodiment, described in connection with the accompanying figures.

FIG. 1A illustrates a functional block diagram of an example processing system that can be utilised to embody or give effect to a particular embodiment;

FIG. 1B illustrates a functional block diagram of an example system that can be utilised to embody or give effect to a particular embodiment;

FIG. 2 is a flowchart representing a method of managing skills acquisition for a user;

FIG. 3 is a flowchart representing a more detailed example method of managing skills acquisition for a user;

FIG. 4 is a flowchart representing an example method of determining a recommended skills acquisition task for a user;

FIG. 5 is a flowchart representing an example method of determining a recommended skills acquisition task for a user based upon target skills acquisition data;

FIG. 6 is a flowchart representing an example method of determining an equivalent skills acquisition task which the user satisfies based on the user's skills competency data; and

FIG. 7 is a table representing skill set data indicative of a set of skills and skill categories with a corresponding skill competency range;

FIG. 8 is a table representing weighting data indicative of a plurality of weighted skill values according to particular skill competency values;

FIG. 9 is a table representing portion data indicative of a plurality of portions of a weighted skill value according to the skill competency value;

FIG. 10 is a table representing a worked example of a plurality of skill code competency values, corresponding weighted skill competency values, a skill code metric, and a plurality of skill category competency metrics;

FIGS. 11A through to 11D are a series of tables representing the determination of an equivalent skills acquisition task for a user;

FIG. 12 is a table representing differential skills competency data for a user;

FIG. 13 is a table representing equivalent certification data for determining an equivalent certification level for a user based upon the skills competency metric;

FIG. 14 is a table representing equivalent certification data for determining an equivalent certification level for user based upon the skills competency metric and one or more certification levels for one or more skill category competency metrics;

FIG. 15 is a flowchart representing an example method of enabling a skills competency search;

FIG. 16 is a block diagram illustrating a system for enabling a skills competency search;

FIG. 17 is a block diagram illustrating a portion of the system of FIG. 16 for recording a task advertisement; and

FIG. 18 is a block diagram illustrating the system of FIG. 16 which shows transfer of search requests and search results for a skills competency search;

FIG. 19 is a flowchart representing another example method of obtaining and storing skills competency data based on data received from a third party.

### DESCRIPTION OF PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

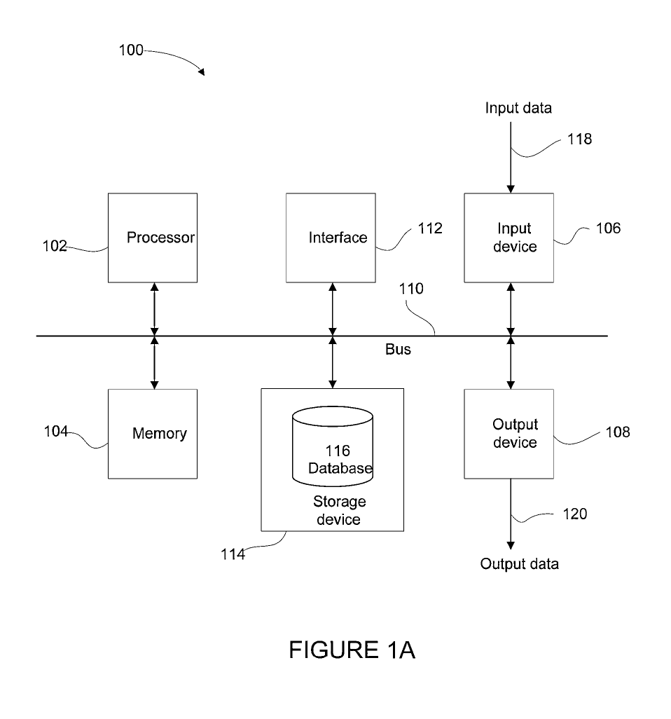

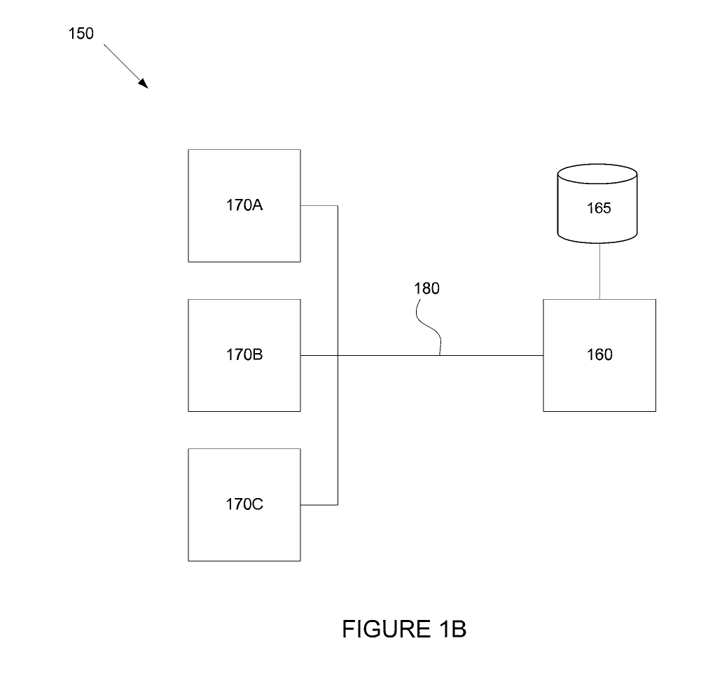

A particular embodiment can be realised using a processing system, an example of which is shown in FIG. 1A. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

Referring to FIG. 1B there is shown a block diagram illustrating a system for managing skills acquisition for a user. In particular the system 150 includes a server processing system 160 in data communication with one or more client processing systems 170 via a communication medium 180, such as a computer network, for example the Internet. The server processing system includes, or is in data communication with, a data store 165 for storing various data as will be described in more detail below. Generally, the data store 165 can be provided in the form of a database or the like. Generally, the server processing system 160 is configured as a web hosting server which hosts a website for presenting an interface to the one or more client processing systems 170 for managing skills acquisition for one or more users. As will be appreciated, the one or more client processing systems 170 can interact with the server processing system 160 via a web-browser application which presents the website hosted by the server processing system 160.

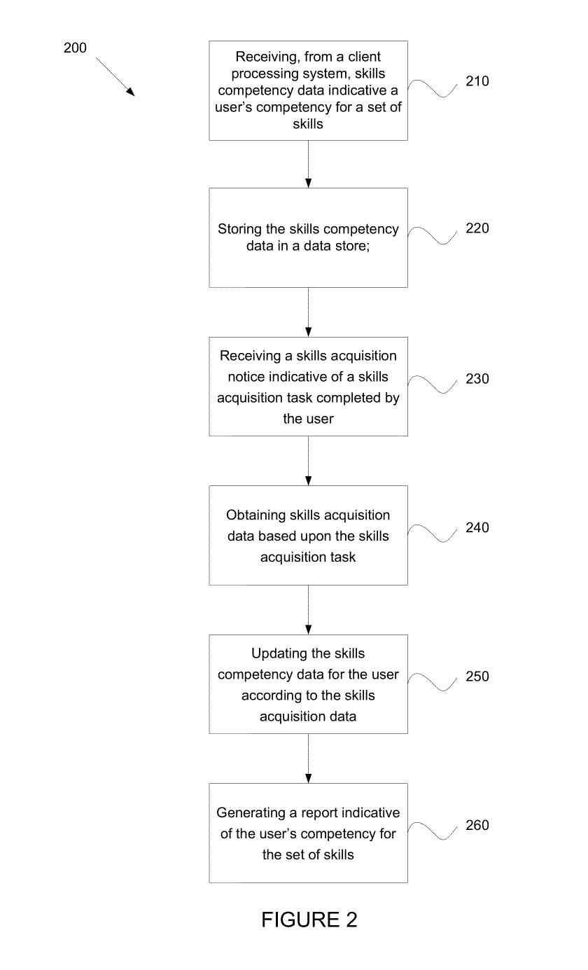

Referring to FIG. 2 there is shown a flowchart representing a method of managing skills acquisition for a user. In particular, at step 210, the method includes, in a server processing system 160, receiving, from a client processing system 170 in data communication with the server processing system 160, current skills competency data indicative a user's competency level for a set of skills. At step 220, the method includes, in the server processing system 160, storing the skills competency data in the data store 165. At step 230, the method includes, in the server processing system 160, receiving a skills acquisition notice indicative of a skills acquisition task completed by the user. At step 240, the method includes, in the server processing system 160, obtaining skills acquisition data based upon the skills acquisition task. At step 250, the method includes, in the server processing system 160, updating the current skills competency data for the user according to the skills acquisition data. At step 260, the method includes generating a report indicative of the user's current competency for the set of skills.

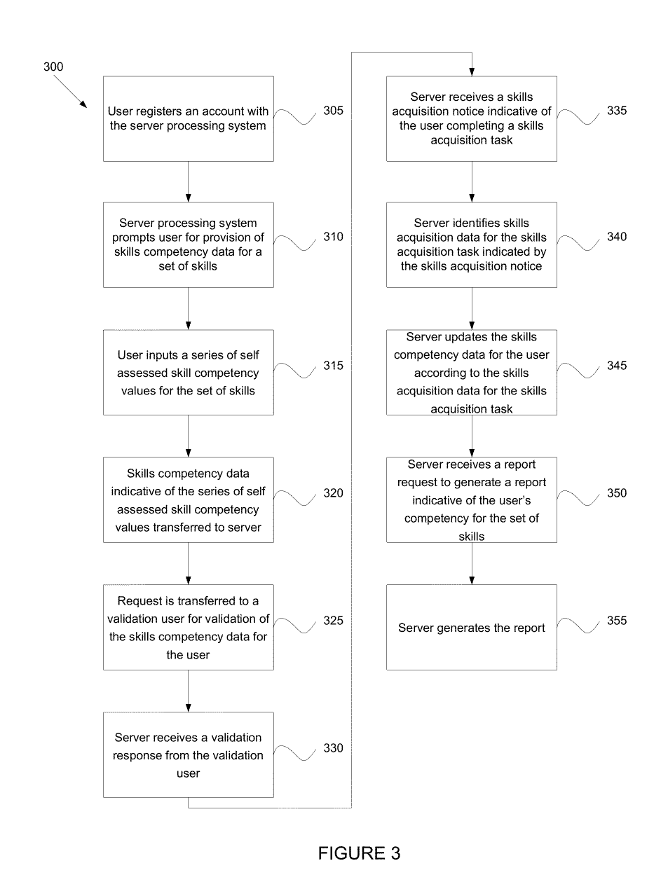

Referring now to FIG. 3, there is shown a flowchart representing a more specific method of managing skills acquisition for a user.

In particular, at step 305, the method 300 includes the user registering an account with the server processing system 160 via one of the client processing systems 170. Generally, the web browser at the client processing system 170 is utilised to communicate with the server processing system 160. The server processing system 170 stores identification data in the data store 165 to allow the user to login to the website on future occasions. In this step, personal data may be requested to be provided by the user to server processing system 160 via the client processing system 170, wherein the personal data can be later used to generate the report, as will be discussed in more detail below.

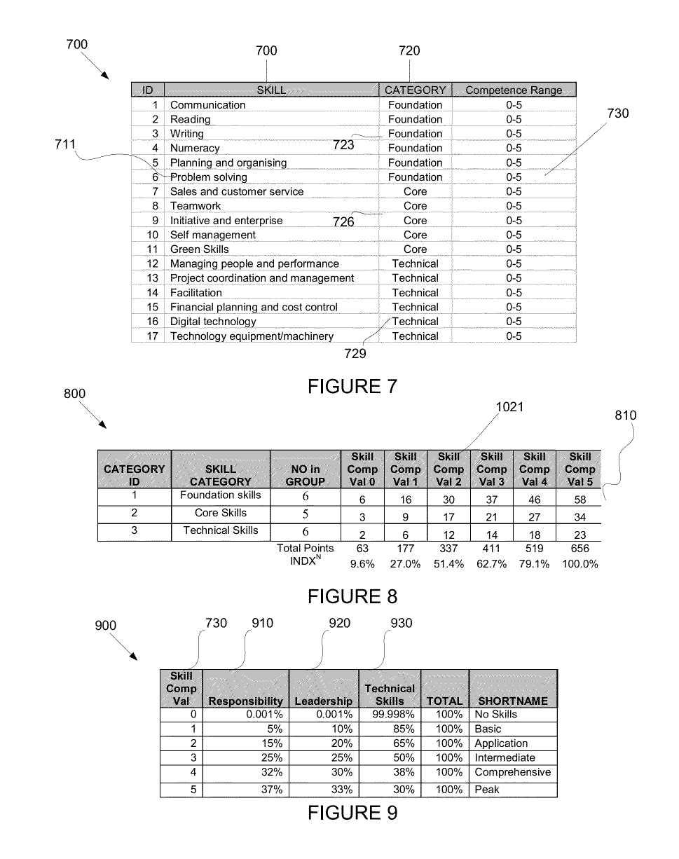

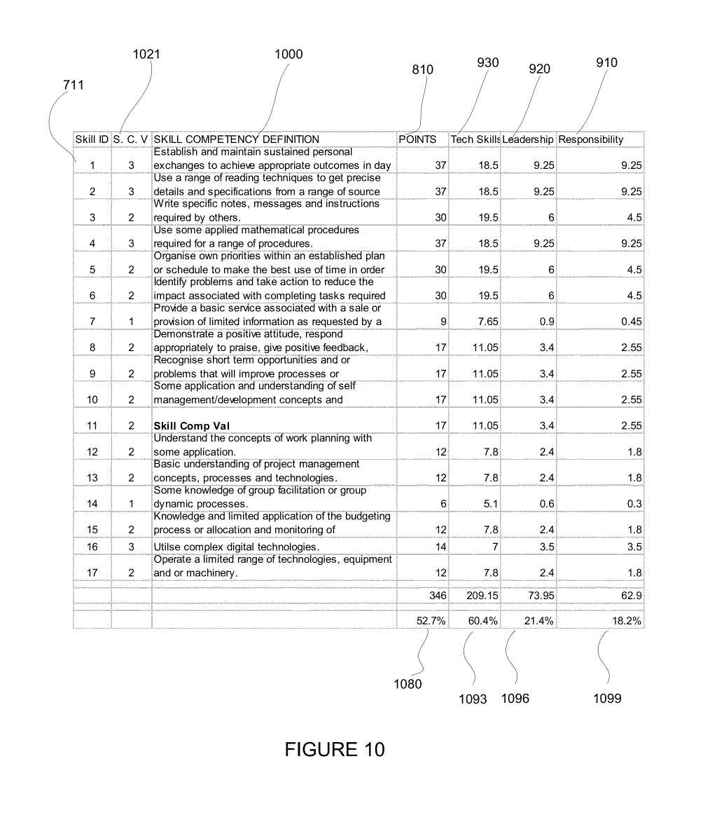

Once logged into the website, the method includes, at step 310, the server processing system 160 transferring electronic form data representing a set of skills to the user at the client processing system 170. The set of skills can include, but not limited to, communication, reading, writing, numeracy, planning and organising, problem solving, sale and customer service, teamwork, initiative and enterprise, self management, green skills, managing people and performance, project coordination and management, facilitation, financial planning and cost control, digital technology, technology, equipment/machinery, as shown by way of example in FIGS. 7 and 10 accordingly.

At 315, the method 300 includes the user inputting a series of self assessed skill competency values 1021 (see FIG. 10) for the set of skills into the electronic form displayed via the client processing system 170. For example, the user may be requested to self assess each skill between a skill competency range of 0 to 5.

At step 320, the method 300 includes the client processing system 170 transferring skills competency data 1020 indicative of the series of self assessed skill competency values 1021 for the set of skills to the server processing system 160 accordingly. The server processing system stores the skills competency data 1020 for the user in the data store 165.

At step 325, the method 300 includes a request being transferred to a validation user for validation of the skills competency data 1020 for the user. In one form, the user can select the validation user from a plurality of validation users via the interface presented at the client processing system 170. A request is then transferred to the validation user, generally via email, to request a validation of the skills competency data 1020 for the user. In one example, the validation user may already know the user and thus is able to validate the skills competency data 1020. In another form, the validation user may arrange for a meeting with the user to assess the user's skill competency for the set of skills to verify the skills competency data 1020.

At step 330, the method 300 includes the server processing system 160 receiving a validation response from the validation user. The validation response can be indicative of the validation user's assessment of the user's competency for the set of skills. In one form, the validation response may indicate that all self-assessed skill competency values 1021 provided by the user are accurate. However, in other examples, the validation user may indicate adjustments to the skills competency data based upon their validation. In some examples, the user may be informed of the adjustment, wherein the user and validation user can discuss the recommended adjustment to the skills competency data 1020 and reach an agreement. It will be appreciated that whilst validation of the skills competency data is preferable, this is an optional process.

At step 335, the method 300 includes the server processing system 160 receiving a skills acquisition notice indicative of the user completing a skills acquisition task. The skills acquisition task indicated by the skills acquisition notice may be a course, program, degree, or the like which the user has undertaken to acquire and improve the user's competency for particular skills of the skill set. In one form, the skills acquisition notice may be received from the user at the respective client processing system 170. In another form, the skills acquisition notice may be received from a third entity operating one of the client processing systems 170. The third entity could be a facilitator of the skills acquisition task undertaken by the user. For example, the third entity could be an educational institution such as a tertiary education organisation, a training program facilitator, or the like.

At step 340, the method 300 includes the server processing system 160 identifying skills acquisition data 1110 for the skills acquisition task 1105 indicated by the skills acquisition notice. In particular, the data store 165 has stored therein a plurality of skills acquisition task records 1101. Each skills acquisition task record 1101 is indicative of a respective skills acquisition task 1105 and corresponding skills acquisition data 1110 indicative of skills acquisition competency values 1120. The server processing system 160 obtains the skills acquisition data 1110 from the data store 165 according to the skills acquisition task 1105 indicated by the skills acquisition notice.

At step 345, the method 300 includes the server processing system 165 updating the skills competency data 1020 for the user according to the skills acquisition data 1110 for the skills acquisition task.

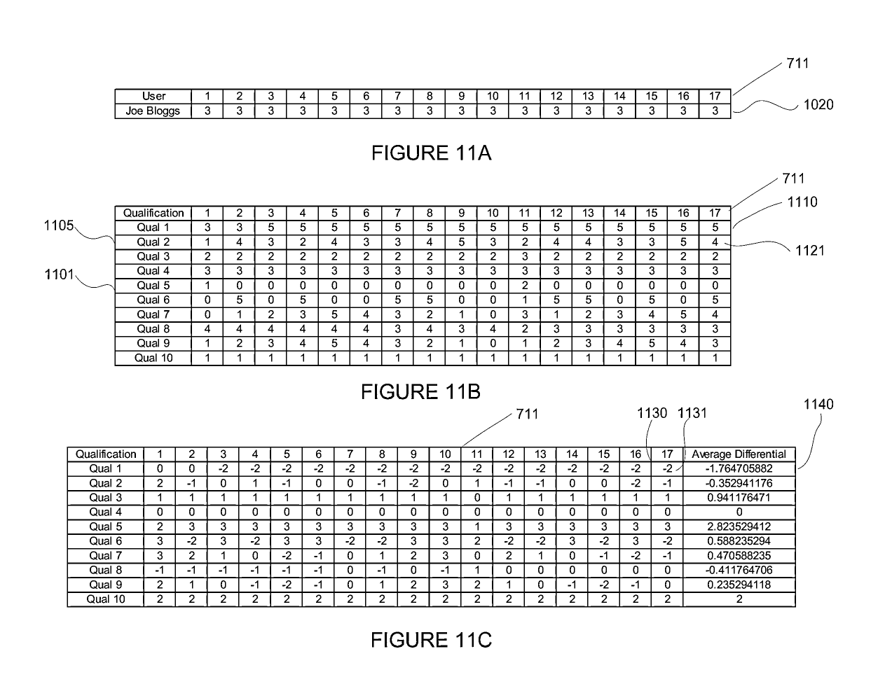

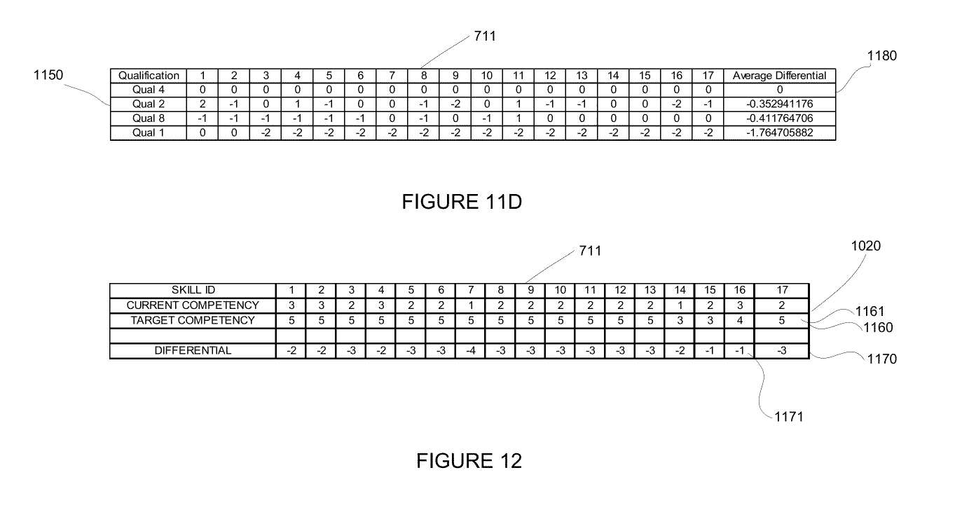

In particular, the skills competency data 1020 and the skills acquisition data 1110 may both be provided in the form of an array of skill competency values as shown for example in FIGS. 11A an 11B. Each skill competency value 1021 of the skills competency data 1020 is compared to the corresponding skills competency value 1121 of the skills acquisition data 1110. In the event that the skill competency value 1021 for a particular skill of the skills acquisition data 1020 is greater than the corresponding skill competency value 1121 of the skills competency data 1110, the respective skill competency value 1021 of the skills competency data 1020 is set to equal to the respective skill competency value 1121 of the skills acquisition data 1110. However, in the event that the skill competency value 1021 for a particular skill of the skills acquisition data 1110 is less than or equal to the corresponding skill competency value 1121 of the skills competency data 1020, the respective skill competency value 1021 of the skills competency data 1020 is left unchanged. This process is performed for each value 1021 of skills competency data 1020.

The skills competency data 1020, once stored in the data store 165 of the server processing system 160 can be associated with a timestamp which is generated and recorded automatically by the server processing system 160. As will be discussed in more detail below, the timestamps associated with the skills competency data 1020 can be utilised for a number of selectable functions provided by the server processing system 160. As will be appreciated, steps 340 and 345 can be repeated a number of times over a particular timeframe as the user acquires competency in particular skills of the skill set.

Additionally, the server processing system stores a skills acquisition task history data indicative of the skills acquisition task completed by the user in the data store 165. A timestamp may also be associated therewith for each skills acquisition task completed by the user.

At step 350, the method 300 includes the server processing system 160 receiving a report request in order for the server processing system 160 to generate the report indicative of the user's competency for the set of skills. The report request can be received from the user via the client processing system 170, however, other users may be able to request the report to be generated if authorised by the user. In particular, the user may record at the data store 165 of server processing system 160 permission data indicative of other users which are able to request a report be generated, wherein the permission data is queried by the server processing system 160 upon receiving a report request from one of the other users of the system 150.

At step 355, the method includes generating the report indicative of the user's competency for the set of skills using the skills competency data 1020 stored in the data store 165. The report may be generated by the server processing system 160 in the form of a curriculum vitae, wherein the report may be generated by the server processing system 160 using the personal data stored in step 305. The report may be an electronic file which is generated and transferred to the client processing system 170. Additionally or alternatively, the report may be printed via a printer (not shown) in data communication with either the client processing system 170 or the server processing system 160.

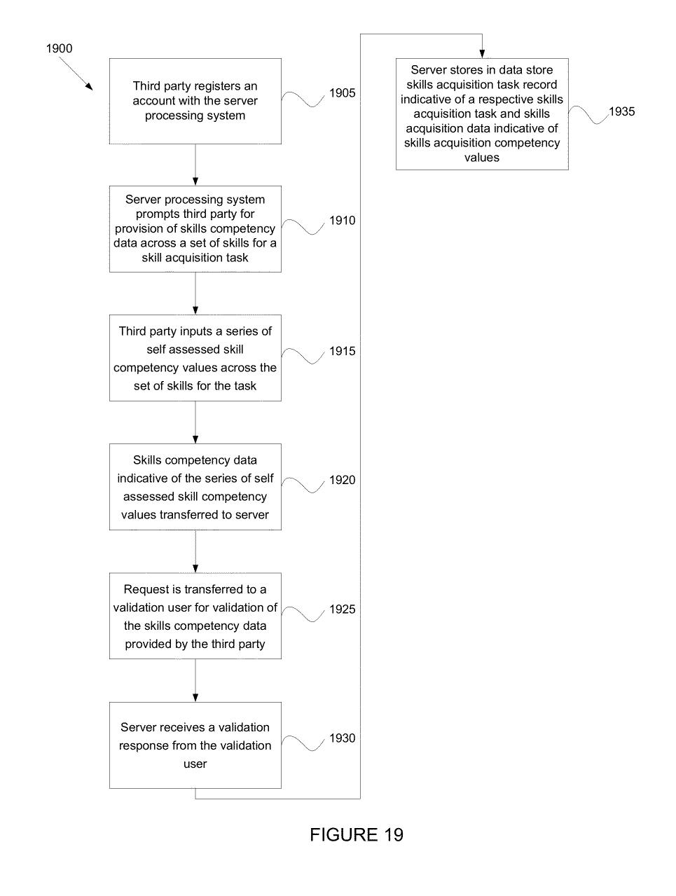

As discussed in FIG. 3, the data store 165 is populated with a plurality of skills acquisition task records 1101. Each skills acquisition task record 1101 is indicative of a respective skills acquisition task 1105 and corresponding skills acquisition data 1110 indicative of skills acquisition competency values 1120. Referring to FIG. 19, there is shown a flowchart illustrating an example method that the skill acquisition task records 1101 can be populated in the data store 165.

In particular, at step 1905 the method 1900 includes a third party registering an account with the server processing system 160. The third party may be an educational institution, an expert in a specific industry or the like. At step 1910, the method 1900 includes the server processing system 160 prompting the third party for provision of skills competency data across a set of skills for a skill acquisition task. The third party may be operating a third party processing system in data communication with the server processing system 160.

At step 1915, the method 1900 includes the third party inputting a series of self assessed skill competency values across the set of skills for the skills acquisition task. At step 1920, the method 1920 includes skills competency data indicative of the series of self assessed skill competency values being transferred from a third party processing system to the server processing system 160. At step 1925, the method 1900 includes the server processing system 160 transferring a request to a validation user for validation of the skills competency data provided by the third party. This step is done similarly to step 325 of method 300.

At step 1930, the method 1900 includes the server processing system 160 receiving a validation response from the validation user. This step is done similarly to step 330 of method 300. At step 1935, the method includes the server processing system 160 storing, in data store 165, a skills acquisition task record 1101 indicative of a respective skills acquisition task 1105 and corresponding skills acquisition data 1110 indicative of skills acquisition competency values 1120 input at step 1915. The data store 165 now has stored therein a skills acquisition task record 1101 which can be used by users to manage their respective skill acquisition.

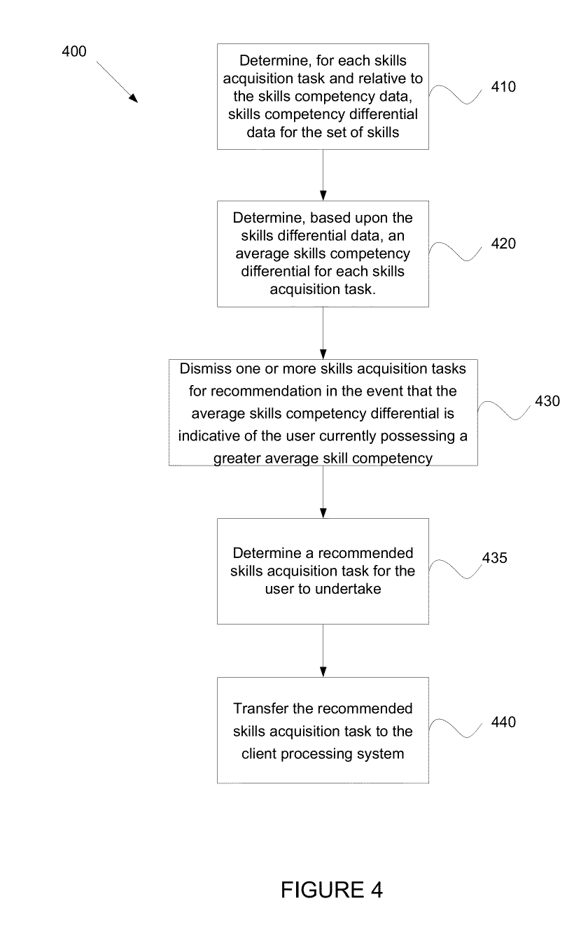

The server processing system 160 may offer a number of selectable functionalities for an individual, or another authorised user of the system 160, to execute in order to manage skills acquisition for the user. A number of these functionalities will now be described in relation to FIGS. 4 to 6. Each of these functions can be selected, for execution at the server processing system, by the respective user via the website presented via the web browser at the respective client processing system 170.

Referring to FIG. 4, there is shown a method 400 of determining a recommended skills acquisition task 1105 for the user. In particular, at step 410 and 420, the method 400 includes comparing the skills competency data 1020 for the user against the skills acquisition data 1110 of the plurality of skills acquisition task records 1101. In particular, at step 410, the method includes determining, for each skills acquisition task 1105 and relative to the skills competency data 1020, skills competency differential data 1030 for the set of skills.

For example, referring to FIG. 11A there is shown an example skills competency data 1020 for a user for seventeen skills. In FIG. 11B there is shown a table representing the skills acquisition data 1110 for a plurality of skills acquisition task records 1101 in the form of a number of qualifications. In FIG. 11C, each skills competency value 1120 of each qualification is subtracted from the corresponding skills competency value 1021 of the skills competency data 1020 of the user to obtain a skills competency differential value 1131, wherein the series of skills competency differential values 1131 form the skills competency differential data 1130 for the skill set as shown in FIG. 11B.

At step 420, the method 400 includes determining, based upon the skills competency differential data 1130, an average skills competency differential 1140 for each skills acquisition task 1105. As shown in FIG. 11D, the skill competency differential values 1131 for the skills competency differential data array 1130 are summed and then divided by the number of skills in the skill set, that being seventeen in this example, to obtain the average skills competency differential 1140 for each skills acquisition task 1105.

At step 430, the method 400 includes dismissing one or more skills acquisition tasks 1105 for recommendation in the event that the average skill differential is indicative of the user currently possessing a greater skills competency average than the respective average skills competency differential. For example, referring to FIG. 11D, the skills acquisition tasks which have a positive average skills competency differential 1040 have been dismissed from recommendation in the table shown in FIG. 11D.

At step 435, the method 400 includes determining a recommended skills acquisition task 1105 for the user to undertake. In particular, the server processing system 160 may determine, based upon the average skills competency differential 1140 and a recommended skills acquisition task rule, the recommended skills acquisition task 1150 for the user.

More specifically, the method 400 can include the server processing system 160 applying the recommended skills acquisition task rule to identify one of the skills acquisition tasks 1105 having an average skills competency differential 1140 which is closest to an optimum average skills competency differential compared to a remainder of the skills acquisition tasks 1105, thereby identifying the recommended skills acquisition task 1150. As would be appreciated, little benefit may be gained by the user in recommending a skills acquisition task 1105 that is too complex based upon their current skills competency data 1020. Additionally, little benefit may be gained by the user if the server processing system recommends a skills acquisition task 1105 where only a small improvement in skill competencies may be acquired by the user. Therefore, the optimum average skills competency differential is set to a value that results in the recommended skills acquisition tasks providing a steady increase in skill competency.

In one specific example, the optimum average skill differential is a configurable value that can be set by an administrator of the server processing system 160 for all users of the system 150. Alternatively, the optimum average skills competency differential may be dynamically adjusted according to skills acquisition notices received for users that successfully undertake a recommended skills acquisition task. In an additional or alternate embodiment, the optimum average skills competency differential is set dynamically for each user according to the user's current skills competency data 1020 and a based upon a change in skills competency data over time for the user. In this embodiment, the timestamp data recorded by the server processing system 160 recording an update to the skills competency data 1020 can be utilised by the server processing system 160 in dynamically determining the optimum average skills competency differential.

Continuing with the example in FIG. 11D, the recommended skills acquisition task rule may identify the skills acquisition task 1105 having an average differential skill value closest to 0.4 as the recommended skills acquisition task 1150. In this instance, the skills acquisition task entitled ‘Qual 8’ has an average skills competency differential average 1140 closest to 0.4 and therefore is identified by the server processing system 160 as the recommended skills acquisition task 1150 for this user.

At step 440, the method 400 includes transferring the recommended skills acquisition task 1150 to the client processing system 170. In one example, the method 400 may determine a plurality of recommended skills acquisition tasks 1150 that satisfy the recommended skills acquisition task rule, such as a recommended skills acquisition task threshold, although specific tasks 1150 may be more highly recommended than others. As such, the server processing system 160 may generate an ordered list of recommended skills acquisition tasks 1150, wherein the ordered list of recommended skills acquisition tasks 1150 is transferred to and presented by the client processing system 170 in descending order of recommendation. Information about each recommended skills acquisition task 1150 may be provided in the list, or alternatively one or more hyperlinks may be provided linking to information about at least some of the recommended skills acquisition tasks.

As will be appreciated, whilst the recommended skills acquisition task 1150 can clearly be beneficial for the specific user, a recruitment agent or the like who is assisting the user obtain employment may also find this method 400 useful in order to provide guidance to the user for increasing employment opportunities. In this particular example, another person other than the user may be operating the client processing system 160 on behalf of the user.

In one variation, the recommended skills acquisition task rule may be dependent upon a frequency distribution analysis of the skills competency differential data. In particular, server processing system, upon application of the recommended skills acquisition task rule, can be configured to give a higher recommendation to a skills acquisition task 1105 that has a greater number of skills of the skill set which are improved upon completion of the skills acquisition task compared to another skills acquisition task 1105 which includes a smaller number of skills of the skill set which are improved, wherein it is likely that the skills improved are improved at an unsustainable level.

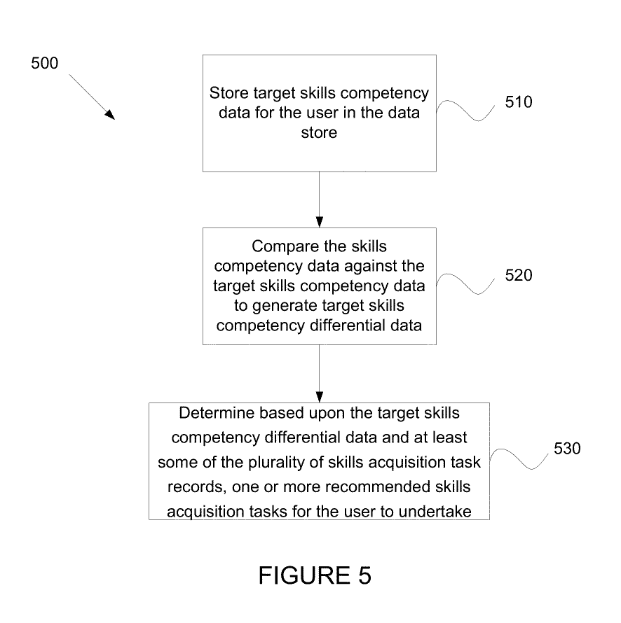

Referring to FIG. 5 there is shown a further flowchart representing a method of determining one or more recommended skills acquisition tasks for the user to undertake based upon target skills competency data 1160.

In particular, at step 510, the method 500 includes storing target skills competency data 1160 for the user in the data store 165. In one form, this can includes the server processing system 160 receiving selection data from the client processing system 170. The selection data can be indicative of a selection made at the client processing system 170 of the target skills competency data 1160 for the user.

More specifically, the selection data can be indicative of a selection of one of the other users as a target user for the user. The server processing system 160 then identifies, from the data store 165 and based upon the selection data, skills competency data 1020 for the target user. The skills competency data 1020 for the target user is stored in the data store 165 as the target skills competency data 1160 for the user. Alternatively, the user, or a third party, may selectively input the target skills competency data 1160 via the client processing system 170.

At step 520, the method 500 includes comparing the skills competency data 1020 against the target skills competency data 1160 to generate target skills competency differential data 1170. Referring to FIG. 12, there is shown an example of target skills competency differential data 1170 calculated for an example user. In particular, the each target skill competency value 1161 of the target skills competency data 1160 which has been selected is subtracted from the corresponding skill competency value 1021 of the skill competency data 1020 to generate the target skills differential data 1170 as shown in FIG. 12.

At step 530, the method includes determining based upon the target skills differential data 1170 and at least some of the plurality of skills acquisition task records 1101, one or more recommended skills acquisition tasks 1150 for the user to undertake. In one form this can include the server processing system 160 attempting to identify one of the skills acquisition tasks 1105 which can be recommended in accordance with the recommended skills acquisition task rule. If no single skills acquisition tasks 1105 can be recommended that satisfy the recommended skills acquisition task rule, the server processing system 160 may determine a plurality or series of recommended skills acquisition tasks that can be undertaken by the user in accordance with the recommended skills acquisition task rule. It will be appreciated that in the instance that a series of recommended skills acquisition tasks 1150 are generated, a particular order of completion may be required and thus a prerequisite ordering of the recommended skills acquisition tasks 1150 may be presented at the client processing system 160 accordingly to indicate the prerequisite nature of the series of the recommended skills acquisition tasks 1150.

In one variation, as discussed above in relation to method 400, the recommended skills acquisition task rule may be additionally dependent upon a frequency distribution analysis of the skills competency differential data for method 500.

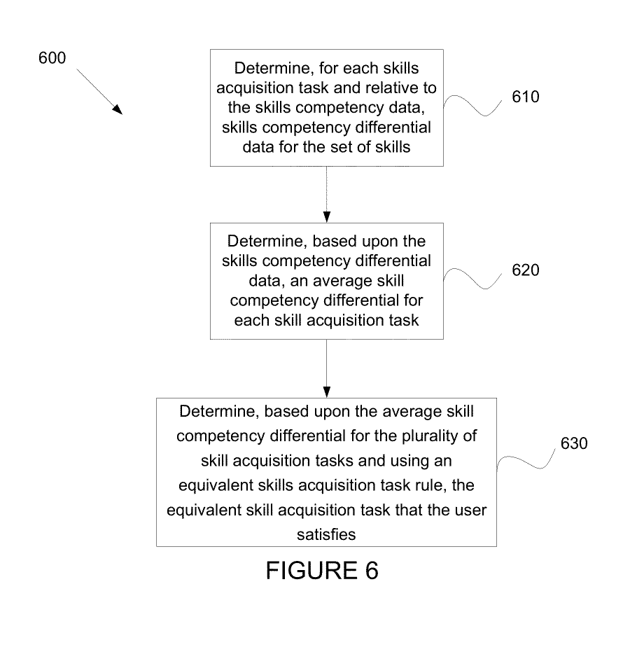

Referring to FIG. 6 there is shown another flowchart representing an example method 600 of the server processing system 160 determining an equivalent skills acquisition task 1180 that the user satisfies based upon the skills competency data 1020 for the user. It will be appreciated that the phrase “equivalent skills acquisition task” is a task that the user has not undertaken, but based upon the user's skill competencies, the user is considered competent for the skills acquisition task 1080. For example, a user who possesses skills competencies indicative of a bachelor of computer engineering may be suitably competent for satisfying a skills acquisition task such as an introductory course to software engineering, despite the user having not undertaken the introductory course.

Referring to FIG. 6, the method includes at, step 610 and 620, the server processing system 160 comparing the skills competency data for the user against the skills acquisition data 1020 of the plurality of skills acquisition task records 1101.

More specifically at step 610, the method includes the server processing system determining, for each skills acquisition task 1105 and relative to the skills competency data 1020, skills competency differential data 1130 for the set of skills. This is performed similarly to that exemplified in relation to method 400. At step 620, the method includes the server processing system 160 determining, based upon the skills competency differential data 1130, an average skills competency differential 1140 for each skills acquisition task 1105. Again, this step can be performed similarly to that described in relation to method 400.

At step 630, the method includes determining, based upon the average skills competency differential 1140 for the plurality of skills acquisition tasks 1105 and using an equivalent skills acquisition task rule, the equivalent skills acquisition task 1180 that the user satisfies. Specifically, the equivalent skills acquisition task rule, stored in the data store 165 and applied by the server processing system 160, can be configured to identify the equivalent skills acquisition task 1180 having an average skills competency differential 1140 that is closest to zero.

As will be appreciated from the method 600, the result of the method 600 can include determining a plurality of equivalent skill tasks 1180 that the user satisfies based upon the skills competency data 1020 for the user. In one form, the report generated is further indicative of the one or more equivalent skills acquisition tasks 1080.

As will be appreciated, the method 600 has similarities to method 400 however the rule to identify the equivalent skill task is different to the rule applied in method 400. In particular, considering the example previously discussed in relation to FIG. 11D, the skills acquisition task entitled ‘Qual 4’ is identified by the server processing system 160 as the equivalent skills acquisition task 1180 due to having an average skills competency differential 1040 that is closest to 0 compared to the other skills acquisition tasks 1105.

Referring to FIG. 7 there is shown a table representing skill set data 700, stored in the data store 165, indicative of the set of skills 710, skill categories 720 with a corresponding skill competency ranges 730. As can be seen, the set of skills are categorised into foundation skills 723, core skills 726, and technical skills 729. As can also be seen in the example, each skill 711 has a skill competency value range 730 between 0 to 5 which can be input at the client processing system 170 as discussed in relation to methods 200 and 300.

Referring to FIG. 8 there is shown a table representing weighting data 800, stored in the data store 165, indicative of a plurality of weighted skill values 810 corresponding to the respective skill competency values 1021. In particular, the skill competency value 1021 that is input for a particular skill 711 has an assigned weighted skill value 810. For example, considering the skill of ‘Communication’, a skill competency value of 4 which is input at the client processing system 170 for this skill is assigned a weighted skill value of 46 due to this skill being categorised as a foundation skill 723. As can be seen from FIG. 8 and from the further examples that will be discussed, particular skills are considered more highly important, and thus weighted accordingly, in terms of a user's equivalent certification level.

Referring to FIG. 9, there is shown a table representing portion data 900, stored in the data store 165, indicative of a plurality of portions of a weighted skill value 810 according to the skill competency value 1021. In particular, the weighted skill value 810 for a particular skill 711 is portioned according to the skill competency value to obtain a responsibility skill value 910, a leadership skill value 920, and a technical skill value 930.

Considering the example discussed in relation to FIG. 8 where a user has a skill competency value of 4 for communication which results in a weighted skill value of 46. In this instance, the skill competency value of 4 results in portioning the 46 points such that the responsibility skill value for communication is 32% of 46 points equalling 15.04 points, the leadership skill value for communication is 30% of 46 points equalling 14.1 points, and the technical skill value for communication is 38% of 46 points equalling 17.86 points.

Referring to FIG. 10, a worked example has be performed for the seventeen skills 710 discussed previously. As shown in FIG. 10, each skill 711 has a respective weighted skill value 1021, responsibility skill value 910, leadership skill value 920, and technical skill value 930. The plurality of weighted skill values can be summed to generate a skills competency metric 1080 which is shown in the figures as INDX^{N}. The skills competency metric 1080 can also be represented as a percentage of the total weighted skill points available, which in this example is 656. As is also shown in FIG. 10, the leadership skills values 920 for the skills 710 can be summed by the server processing system 160 to generate a leadership skills competency metric 1096 which can be expressed as a percentage of the skills competency metric 1080. A technical skills competency metric 1093 and responsibility skills competency metric 1099 can be similarly calculated by the server processing system 160 to that of the leadership skills competency metric 1096 accordingly. The leadership skills competency metric 1096, the technical skills competency metric 1093 and the responsibility skills competency metric 1099 are collectively referred to as skill category competency metrics 1090.

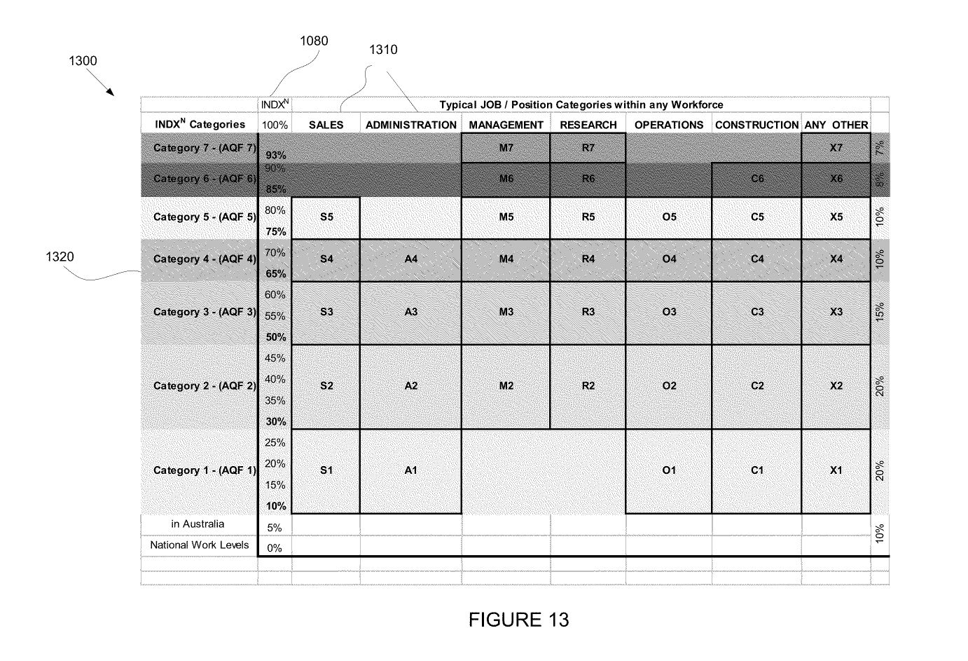

Referring to FIG. 13 there is shown an example of a certification level data 1300, stored in the data store 165, indicative of certification level table for a plurality of professions 1310. The server processing system 165 can use the skills competency metric 1080 and the certification level data 1300 stored in the data store 165, to determine an equivalent certification level 1320 for the user for varying professions.

For example, the user of FIG. 10 may indicate in the personal data collected by the server processing system 160 that the user operates in the construction industry. In this example, the user may be considered to have a Certificate III (C3) equivalent certification based on the user's skills competency metric 1080. As can be seen in FIG. 13, multiple certification levels are mapped within the certification data, thereby allowing corresponding certification levels for multiple professions and national frameworks to be identified by the server processing system for a user accordingly.

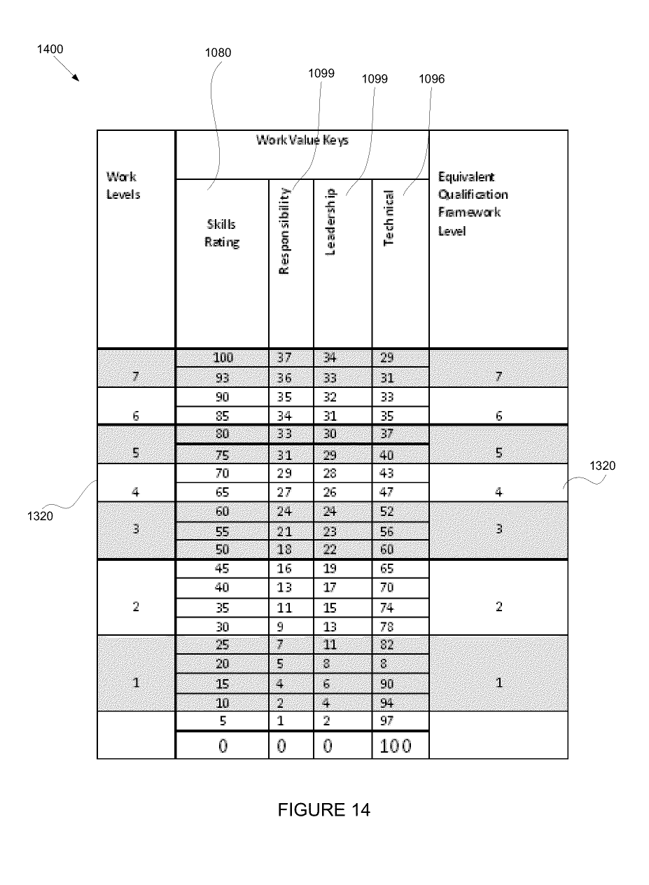

Referring to FIG. 14, an alternate certification lookup table 1400 is provided. In one form, the server processing system 160 may use the technical skills competency metric 1093, the responsibility skills competency metric 1099, and/or the leadership skills competency metric 1096 to determine and store a certification level 1320 for each metric 1090.

In a particular example, the server processing system is configured 160 to generate the report to further be indicative of the one or more equivalent certification levels 1320 for the user for the skills competency metric 1080, the technical skills competency metric 1093, the responsibility skills competency metric 1099, and/or the leadership skills competency metric 1096. The server processing system 160 may generate the report to include skill competency definitions 1000 which describe the competency that the user possesses for each particular skill. The data store 165 generally stores skill definition data which is used by the server processing system 165 to generate the report indicative of the skill competency definitions. In one form, each skill 711 may have dual skill competency definitions which are stored in the data store 165. For example, for the skill of communication, the dual skill competency definitions may relate to speaking and listening. The server processing system 160 can be configured to utilise particular template data stored in the data store 165 for generating the report. The server processing system 160 can be configured to generate graphs such as bar charts, pie charts, and the like to graphically depict the skill competency data 1080 of the user in the report. The report can also include a table or graph indicative of the user's historical skills competency acquisition.

In another variation, the server processing system 160 may adjust, on a periodic basis, at least some of the skill competency values 1021 of the skills competency data 1020 in accordance with a temporal skills competency rule and a record of completed skills acquisition tasks undertaken by the user. In particular, this functionality reflects the concept that the competency that a particular user possesses for one or more skills of the skill set may fade over time without regular skills competency updates.

For example, a computer engineer working as a patent attorney may have once possessed substantial competency for digital technology when undertaking a computer engineering degree, however over time, this competency may have reduced due to the nature of the respective workplace. As such, the respective user may be recommended by the server processing system to undertake one or more skills acquisition tasks to maintain a level of skill competency for a particular skill of the skill set. In one embodiment, the server processing system may identify when such a skills competency adjustment may occur for one or more of the skill acquisition values of the user skills acquisition data and warn the user at the client processing system accordingly, such as providing a deadline, in order to avoid the skills acquisition data adjustment. The warning may include a recommendation of one or more skills acquisition tasks for the user to undertake to maintain the skill competency value for the skill in question.

It will be appreciated that each skills acquisition task may be one or a qualification, a certification level, or the like.

It will be appreciated that a computer program product may also be provided which includes a computer readable medium having stored therein computer executable instructions for configuring the server processing to perform one or more of the methods hereinbefore described. Similarly, it will be appreciated that a server processing system similar to that of processing system 100 can be configured to perform one or more of the methods hereinbefore described.

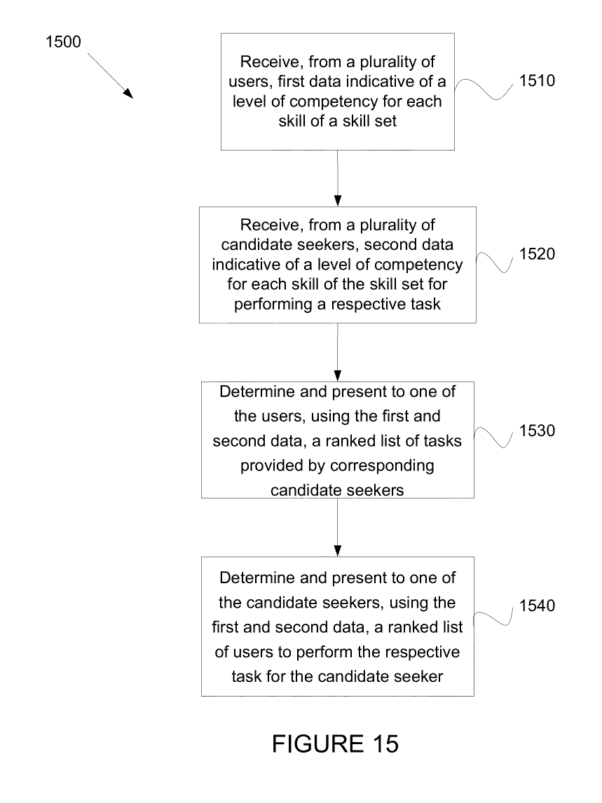

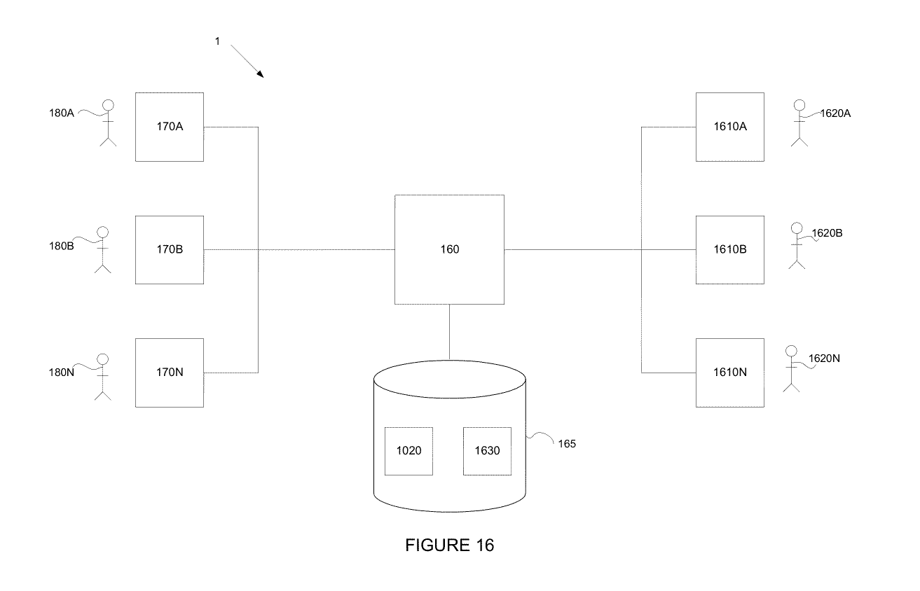

Referring to FIG. 15 there is shown a flowchart representing an example method 1500 of enabling a skills competency search. The method 1500 is performed by the server processing system 160 such that the server processing system 160 assists with skills management and enables skills competency search. The method 1500 will be described with reference to the block diagram illustrated in FIG. 16 which shows an example system for enabling a skills competency search.

At step 1510, the method 1500 includes receiving, from a plurality of users, first data indicative of a user's level of competency for each skill of a skill set.

At step 1520, the method 1500 includes receiving, from a plurality of candidate seekers, second data indicative of a level of competency for each skill of the skill set which each candidate seeker desires for performing a respective task.

At step 1530, the method 1500 includes determining and presenting to one of the users, using the first and second data, a ranked list of tasks provided by corresponding candidate seekers.

At step 1540, the method 1500 includes determining and presenting to each candidate seeker, using the first and second data, a ranked list of users to perform the respective task for the candidate seeker.

The method 1500 advantageously allows for the ranked list of tasks to be returned to the searching user that is relevant for the user's level of competency for the skills of the skill set. Additionally, the candidate seeker is advantageously able to conduct a search of potential candidates (i.e. users of the skills management system) based on the level of competency that the candidate seeker requires for the task to be performed. Thus, by enabling the candidate seeker to obtain the ranked list of users based on the level of competency for skills desired for the task, the candidate seeker can play a more active role in obtaining a user for performing the task.

As will be appreciated, the task may be an employment opportunity such as a job that has been advertised by an employer, wherein the employer is the candidate seeker. In other examples, the task may be a portion of a project to be carried out by an organisation, wherein the organisation seeks current employees to work upon the project based upon their current level of competency for a skills set.

Each candidate seeker 1620A, 1620B, 1620N (generically referred to by reference number 1620) is able to access a login website hosted by the server processing system 160 in order to login to the system 1600. Each candidate seeker 1620 may use a candidate seeker processing system 1610 (i.e. candidate seeker 1620A uses candidate seeker processing system 1610A, candidate seeker 1620B uses candidate seeker processing system 1610B, and candidate seeker 1620N uses candidate seeker processing system 1610N) that is in data communication with the server processing system 160 to login. Upon successful authentication, the server processing system 160 presents an interface to the candidate seeker 1620 for enabling a skills competency search.

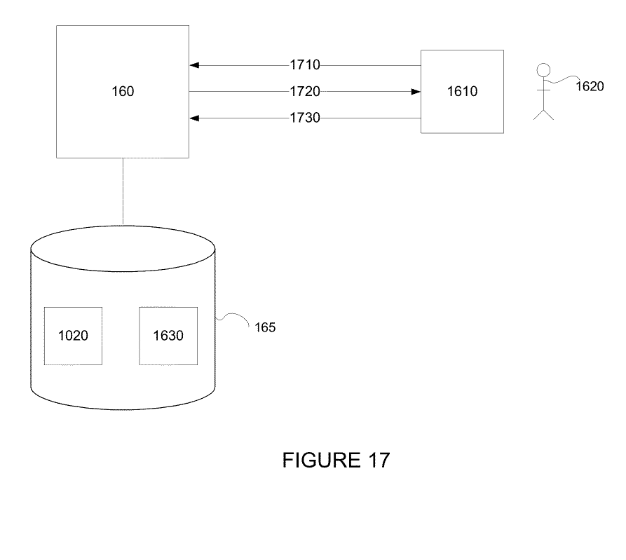

As shown in FIG. 17, a candidate seeker 1620 transfers to the server processing system 160, via the candidate seeker processing system 1610, a request 1710 to generate a task advertisement. The server processing system 160 transfers a form 1720 to the candidate seeker processing system 1610 to allow the candidate seeker 1620 to define the competency levels for a set of skills desired for performing a task. The form may also require a description of the task and potentially a task category such as an industry or the like. The candidate seeker 1620 may also indicate whether only users of a particular organisation are able to apply for performing the task. For example, the candidate seeker 1620 of an organisation may wish for the task to be performed by a user who is already employed by the organisation. Upon completing the form, task advertisement data 1730 is transferred to the server processing system 160 for recordal in the database 165 accordingly as one of a plurality of task advertisement records 1630. Each task advertisement record 1730 is preferably indicative of the identity of the candidate seeker 1620.

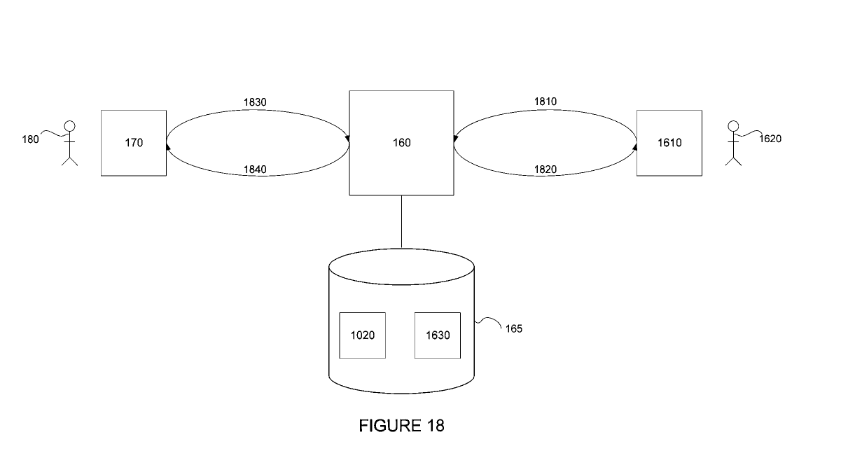

Referring to FIG. 18, the candidate seeker 1620 can select from the interface presented by the server processing system 160 that a skills competency search is to be performed to identify a user to perform a task. In one form, upon requesting a skills competency search, the server processing system 160 retrieves any task advertisement records 1730 stored in the database 165 associated with the candidate seeker 1620. The candidate seeker 1620 can then select the task 1730 that the candidate seeker 1620 wishes to seek potential users for performing. By enabling the candidate seeker 1620 to select from advertised tasks, the candidate seeker 1620 avoids entering skills competency data to define search criteria for performing the search. However, it is possible that the candidate seeker 1620 can input search criteria including skills competency data via the input device of the candidate seeker processing system 1610 in order to define the search criteria.

Once the search criteria has been defined, the candidate seeker 1620 can interact with the interface to cause candidate search request data 1810 indicative of the search criteria to be transferred from the candidate seeker processing system 1610 to the server processing system 160. The search criteria is indicative of the desired competency level for each skill of the skill set for the task which is herein referred to as the task skills competency data.

The server processing system 160 then performs a comparison of the task skills competency data against the skills competency data 1020 for the plurality of users 180 of the system 1. The comparison performed by the server processing system 160 results in a ranked list of potential users 1820 which at least partially satisfy the search criteria.

A number of comparison techniques can be performed by the server processing system 160 to identify users which at least partially satisfy the search criteria. The candidate seeker 1620 may select, whilst configuring the search criteria, the comparison technique which is to be used by the server processing system 160 to generate the ranked list 1820.

One comparison technique includes the server processing system 160 determining a task skills competency metric for the task skills competency data according to the method described in relation to FIG. 10. This may be calculated by the server processing system 160 or may be retrieved from the database 165 due to being calculated on a previous occasion by the server processing system 160. The server processing system 160 then determines the skills competency metric 1080 for each user 180 of the system 1. In a preferable form, the skills competency metric 1080 for each user 180 has been previously calculated and stored in the database 165, thus the server processing system 160 retrieves the skills competency metric 1080 for each user 180 from the database 165. The server processing system 160 then compares the task skills competency index against the skills competency index 1080 for each user 180, wherein the server processing system 160 determines an index differential (i.e. the difference between the task skills competency index and the skills competency index for a particular user) for each user 180 of the comparison. The server processing system 160 then generates the list of users 1820 ranked according to the index differential (i.e. users having a low index differential are ranked higher in the list 1820 compared to users having a higher index differential).

In another comparison technique, the server processing system 160 compares the skill competency level for each skill in the task skill competency data against each corresponding skill competency level for the each corresponding skill of each user 180. The comparison includes the server processing system 160 determining the skill competency differential value for each skill for the task skill competency data and the skill competency data 1020 for each user. This technique results in the server processing system 160 generating skills competency differential data for each user 180 as described in relation to FIG. 11A.

Once the server processing system 160 has generated skills competency differential data for each user 180, the server processing system 160 can determine an average skills competency differential for each user 180 using the respective skills competency differential data as previously described in relation to FIG. 11D. In particular, the differential values are summed by the server processing system 160 for a particular user 180 and then divided by the number of skills of the skill set to determine the average skills competency differential for the user 180. Users 180 are then ranked in ascending order in the list 1820 according to the respective average skills competency differential, wherein users having a low average skills competency differential are ranked higher in the list compared to users having a higher average skills competency differential.

Alternatively, once the server processing system 160 has generated skills competency differential data for each user 180, the server processing system 160 can generate skill competency differential frequency distribution data for each user 180. In particular, this technique results in determining a frequency of skill competency differential values which a particular user 180 possesses relative to the task skills competency data. For example, the skill competency differential frequency distribution data generated for a particular user 180 can be indicative of five skills which the user has a skill competency level which exactly matches the desired competency indicated by the task skills competency data, four skills which the user has a skill competency level which is one skill competency level below the desired competency indicated by task skills competency data, and eight skills which the user has a skills competency level which is one skill competency level above the desired competency indicated by the task skills competency data. The server processing system 160 then ranks the users 180 in the list 1820 in descending order according to the number of skills which exactly match the task skills competency data (i.e. users having a higher number of skills which exactly match the task skills competency data are ranked higher than users having a lower number of skills which exactly match the task skills competency data). Users 180 having the same number of skills which match task skills competency data can then be ordered by the server processing system 160 according to the number of skills which the user possesses which is one skill competency level below or above the task skill competency data, and so on.

Upon the server processing system 160 generating the ranked list of users, ranked user data 1820 indicative of the ranked list of users is then transferred to the candidate seeker processing system 1610 for presentation to the candidate seeker 1620. The server processing system 160 may only select a portion of the ranked list of users for transferring to the candidate seeker processing system 1610. For example, the server processing system 160 may store a predefined value in memory indicative of the number of records which are to be presented to the candidate seeker 1620. The top predefined number of records in the list is then transferred to the candidate seeker processing system 1610 for review by the candidate seeker 1620. The ranked user data 1820 may additionally include the skills competency data 1020 for each user which is presented to the candidate seeker for review. The ranked user data 1820 may additionally provide a link for the candidate seeker 1620 to contact any one of the users 180 presented in the ranked list 1820. The link may be an email address or alternatively a link to a message delivery system hosted by the server processing system 160 which delivers a message to the selected user 180 via the server processing system 160 when the user 180 logs into the system 1.

A candidate seeker 1620 may additionally indicate in the search criteria that the search results 1820 generated by the server processing system 160 and returned to the candidate seeker 1620 are determined according to whether a potential user is already employed by the organisation. For example, the candidate seeker 1620 can provide search criteria limiting the search results to only include potential candidates who are employed by the organisation. In this situation, the server processing system 160 identifies a subset of users 180 which are already associated with an organisation based on data stored in the database 165. Once the subset of users 180 has been identified by the server processing system 160, the skills comparison process can be performed by the server processing system 160 as described above.

Additionally or alternatively, as described above, the search criteria may be indicative of users 180 who are able to perform a task for a particular task category such as a particular industry (i.e. legal industry, building industry, etc). Similar to above, the server processing system 160 can identify, based on the user records stored in the database 165, a subset of users 180 which are able to perform a task for a particular industry and then perform the skills comparison process as described above.

As described above, each user 180 of the system 1 is also able to interact with the server processing system 160 via a respective user processing system 170 to conduct a search for advertised tasks 1630, wherein search criteria of the search is based upon the skills competency data 1020 recorded for the user 180 in the database 165.

In particular, upon logging into the system 1 via entering username and password data as described above via the website hosted by the server processing system 160, the user 180 is able to select from the interface a request to perform a task search. The user's processing system transfers task search request data 1830 to the server processing system 160 requesting the server processing system 160 to perform the search.

Upon receiving the task search request 1830, the server processing system 160 identifies the skills competency data 1020 for the user 180 in the database 165. The server processing system 160 then compares the skills competency data 1020 for the user 180 against the task skills competency data 1630 recorded in the database 165 for each advertised task, and based on the comparison the server processing system 160 generates a ranked list of tasks. Ranked task data 1840 is then transferred to the user processing system 170 for review by the user 180. The ranked task data 170 can include a link to contact the candidate seeker 1620 for a particular task listed in the ranked list of tasks. The link may be an email address of the candidate seeker 1620 or alternatively a link to a message delivery system hosted by the server processing system 160 which enables the user 180 to deliver an electronic message to the selected candidate seeker 1620 via the server processing system 160, wherein upon the selected candidate seeker 1620 logging into the system 1, the candidate seeker 1620 can review the message.

The comparison performed by the server processing system 160 between the user skills competency data 1020 and the task skills competency data 1630 for each advertised task can be performed using the same comparison techniques described above. The user 180 may be able to select the comparison technique which is used by the server processing system 160 to generate the ranked list of tasks.

For example, the server processing system 160 can compare the user's skills competency index 1080 against each task skills competency index for each advertised task to determine a plurality of index differentials, wherein the list of tasks are ranked in ascending order according to the index differentials.

Alternatively, the server processing system 160 can generate skills competency differential data for each task relative to the user's skill competency data 1020. In one form, the server processing system 160 calculates an average skills competency differential value for each task, wherein the list of tasks is ranked in ascending order according to the average skills competency differential values. In another form, the server processing system 160 determines skill competency differential frequency distribution data for each task, wherein the list of tasks are ranked in descending order according to the number of skills that exactly match the user's competency level for the skill set.

The user 180 may also define additional search criterion for the server processing system 160 to generate the search results. In particular, the user may indicate that tasks advertised by a particular organisation are to be presented in the search results. The server processing system 160 can identify a subset of advertised tasks associated with the organisation, and then perform the comparison based upon the selected subset of advertised tasks. Additionally or alternatively, a task may have been advertised for users of a particular organisation, wherein in the event that the searching user is not part of the organisation specified by the respective candidate seeker 1620, the respective task is eliminated from the searchable subset of tasks. Additionally or alternatively, the user 180 may define a task category such as industry search criterion. The server processing system then identifies from the database a subset of advertised tasks which relate to the task category specified by the user, wherein the comparison is performed by the server processing system 160 upon the subset of advertised tasks.

Many modifications will be apparent to those skilled in the art without departing from the scope of the present invention.

1-24. (canceled)

25. A server processing system for managing skills acquisition for a user, wherein the server processing system is configured to:
receive, from a client processing system in data communication with the server processing system, skills competency data indicative a user's competency for a set of skills;
store the skills competency data in a data store;
receive a skills acquisition notice indicative of a skills acquisition task completed by the user;
obtain skills acquisition data based upon the skills acquisition task;
update the skills competency data for the user according to the skills acquisition data; and
generate a report indicative of the user's competency for the set of skills.

26-31. (canceled)

32. The server processing system according to claim 25, wherein the data store has stored therein a plurality of skills acquisition task records, wherein each skills acquisition task record is indicative of a respective skills acquisition task and corresponding skills acquisition data, wherein the server processing system is configured to obtain the skills acquisition data from the data store according to the skills acquisition task indicated by the skills acquisition notice.

33. The server processing system according to claim 32, wherein the skills competency data and the skills acquisition data are arrays including a plurality of skill competency values indicative of a degree of competency for the set of skills.

34. The server processing system according to claim 33, wherein the server processing system is configured to:
compare the skills competency data for the user against the skills acquisition data of the plurality of skills acquisition task records;
determine a recommended skills acquisition task for the user to undertake; and
transfer the recommended skills acquisition task to the client processing system.

35. The server processing system according to claim 34, wherein the server processing system is configured to:
determine, for each skills acquisition task and relative to the skills competency data, skills competency differential data for the set of skills;
determine, based upon the skills competency differential data, an average skills competency differential for each skills acquisition task; and
determine, based upon the average skills competency differential and a recommended skills acquisition task rule, the recommended skills acquisition task for the user.

36. The server processing system according to claim 35, wherein the server processing system is configured to dismiss one or more skills acquisition tasks for recommendation in the event that the average skills competency differential is indicative of the user currently possessing a greater average skills competency for the set of skills.

37. The server processing system according to claim 36, wherein the server processing system is configured to apply the recommended skills acquisition task rule to identify one of the skills acquisition tasks having an average skills competency differential which is closest to an optimum average skills competency differential compared to a remainder of the skills acquisition tasks, thereby identifying the recommended skills acquisition task.

38. The server processing system according to any one of claims 35 to 37, wherein the skills acquisition task rule is dependent upon a frequency distribution data generated by the server processing system upon the skills competency differential data.

39. The server processing system according to any one of claims 34 to 38, wherein the server processing system is configured to determine an ordered list of recommended skills acquisition tasks, wherein the ordered list of recommended skills acquisition tasks is transferred to and presented by the client processing system in descending order of recommendation.

40. The server processing system according to any one of claims 33 to 38, wherein the method includes, in the server processing system, steps of:
store target skills competency data for the user in the data store;
compare the skills competency data against the target skills competency data to generate target skills competency differential data; and
determine based upon the target skills competency differential data and at least some of the plurality of skills acquisition task records, one or more recommended skills acquisition tasks for the user to undertake.

41. The server processing system according to claim 39, wherein the server processing system is configured to manage skills acquisition for a plurality of other users, wherein the server processing system is configured to:
receive the selection data indicative of a selection of one of the other users as a target user for the user;
identify, from the data store and based upon the selection data, skills competency data for the target user; and
store the skills competency data for the target user as the target skills competency data for the user.

42. The server processing system according to any one of claims 34 to 40, wherein the server processing system is configured to compare the skills competency data for the user against the skills acquisition data of the plurality of skills acquisition task records to determine an equivalent skills acquisition task which the user satisfies based upon the skills competency data for the user.

43. The server processing system according to claim 41, wherein the server processing system is configured to:
determine, for each skills acquisition task and relative to the skills competency data, skills competency differential data for the set of skills;
determine, based upon the skills competency differential data, an average skills competency differential for each skills acquisition task; and
determine, based upon the average skills competency differential for the plurality of skills acquisition tasks and using an equivalent skills acquisition task rule, the equivalent skills acquisition task which the user satisfies.

44. The server processing system according to claim 43, wherein the server processing system is configured to apply the equivalent skills acquisition task rule to identify the equivalent skills acquisition task having an average skills competency differential which is closest to zero.

45. The server processing system according to any one of claims 33 to 42, wherein the server processing system is configured to:
determine a skills competency metric based upon the skills competency data for the user; and
record, in the data store, the skills competency metric for the user.

46. The server processing system according to claim 43, wherein the server processing system is configured to determine the skills competency metric by performing a weighted summation of the plurality of skill competency values for the skills competency data for the user.

47. The server processing system according to claim 25, wherein the server processing system is configured to enable a skill competency search, wherein the server processing system is configured to:
receive, from a plurality of users, skills competency data indicative each user's competency for the set of skills;
receive, from a plurality of candidate seekers, desired skills competency data indicative of a desired level of competency for each skill of the skill set which a respective candidate seeker desires for performing a respective task;
determine, for one of the users and based on the skills competency data and the desired skills competency data, a ranked list of tasks provided by corresponding candidate seekers;
present, to the respective user, the ranked list of tasks provided by corresponding candidate seekers;
determine, for one of the candidate seekers and based on the skills competency data and the desired skills competency data, a ranked list of users to perform the respective task for the candidate seeker; and
present, to the respective candidate seeker, the ranked list of users to perform the respective task for the candidate seeker.

48. A non-transitory computer-readable medium having computer executable instructions stored thereon for execution by one or more processors of a server processing system to manage skills acquisition for a user, wherein the computer executable instructions when executed by the server processing system causes the server processing to:
receive, from a client processing system in data communication with the server processing system, skills competency data indicative a user's competency for a set of skills;
store the skills competency data in a data store;
receive a skills acquisition notice indicative of a skills acquisition task completed by the user;
obtain skills acquisition data based upon the skills acquisition task;
update the skills competency data for the user according to the skills acquisition data; and
generate a report indicative of the user's competency for the set of skills.

49. The computer-readable medium according to claim 48, wherein the computer readable medium configures the server processing system to enable a skill competency search, wherein the computer readable medium configures the server processing system to:
receive, from a plurality of users, skills competency data indicative each user's competency for the set of skills;
receive, from a plurality of candidate seekers, desired skills competency data indicative of a desired level of competency for each skill of the skill set which a respective candidate seeker desires for performing a respective task;
determine, for one of the users and based on the skills competency data and the desired skills competency data, a ranked list of tasks provided by corresponding candidate seekers;
present, to the respective user, the ranked list of tasks provided by corresponding candidate seekers;
determine, for one of the candidate seekers and based on the skills competency data and the desired skills competency data, a ranked list of users to perform the respective task for the candidate seeker; and
present, to the respective candidate seeker, the ranked list of users to perform the respective task for the candidate seeker.

50. A server processing system for enabling a skill competency search, wherein the server processing system is configured to:
receive, from a plurality of users, skills competency data indicative each user's competency for the set of skills;
receive, from a plurality of candidate seekers, desired skills competency data indicative of a desired level of competency for each skill of the skill set which a respective candidate seeker desires for performing a respective task;
determine, for one of the users and based on the skills competency data and the desired skills competency data, a ranked list of tasks provided by corresponding candidate seekers;
present, to the respective user, the ranked list of tasks provided by corresponding candidate seekers;
determine, for one of the candidate seekers and based on the skills competency data and the desired skills competency data, a ranked list of users to perform the respective task for the candidate seeker; and
present, to the respective candidate seeker, the ranked list of users to perform the respective task for the candidate seeker.
